(19) United States
(12) Patent Application Publication
(10) Pub. No.: US 2022/0398055 A1
(43) Pub. Date: Dec. 15, 2022

(54) ARTIFICIAL INTELLIGENCE BASED MULTI-APPLICATION SYSTEMS AND METHODS FOR PREDICTING USER-SPECIFIC EVENTS AND/OR CHARACTERISTICS AND GENERATING USER-SPECIFIC RECOMMENDATIONS BASED ON APP USAGE

(71) Applicant: The Procter & Gamble Company, Cincinnati, OH (US)

(72) Inventors: Jennifer Joan GUSTIN, Cincinnati, OH (US); Brooks R. FIESINGER, Cincinnati, OH (US); Oya ARAN KARAKUS, Montgomery, OH (US); Roland ENGEL, Cincinnati, OH (US); Donald Carroll ROE, West Chester, OH (US); Kelly L. ANDERSON, Mason, OH (US); Ming CHEN, Mason, OH (US)

(21) Appl. No.: 17/836,372

(22) Filed: Jun. 9, 2022

Related U.S. Application Data
(60) Provisional application No. 63/209,564, filed on Jun. 11, 2021.
(60) Provisional application No. 63/216,236, filed on Jun. 29, 2021.
(60) Provisional application No. 63/350,466, filed on Jun. 9, 2022.

(51) Int. Cl. G06F 3/14; H04L 67/50; G06Q 30/06; G06N 20/20

(52) U.S. Cl. CPC G06F 3/14; H04L 67/535; G06Q 30/0631; G06N 20/20

(57) ABSTRACT

Artificial intelligence (AI) based multi-application (app) systems and methods are described for predicting user-specific events and/or characteristics and generating user-specific recommendations based on app usage. A training data set comprising a plurality of previous predictive outputs of multiple existing AI apps is aggregated and is used to train an ensemble AI model operable to predict events and/or characteristics of respective users. App data usage of a user is analyzed by the ensemble AI model to determine a predicted event and/or characteristic of the user, and a user-specific electronic recommendation is generated therefrom that is designed to address the predicted event and/or characteristic. The user-specific electronic recommendation may be rendered on a display screen of a user computing device.

### RELATED APPLICATIONS

This application claims the benefit of U.S. Provisional Application No. 63/209,564, filed on Jun. 11, 2021; U.S. Provisional Application No. 63/216,236, filed on Jun. 29, 2021; and U.S. Provisional Application No. 63/350,466, filed on Jun. 9, 2022. The entirety of each of the foregoing provisional applications is incorporated by reference herein.

### FIELD

The present disclosure generally relates to artificial intelligence (AI) based multi-application (app) systems and methods, and more particularly, to AI based multi-app systems and methods for predicting user-specific events and/or characteristics and for generating user-specific recommendations based on app usage.

### BACKGROUND

Currently, digital applications (apps), such as mobile apps, work in isolation, providing benefits pertaining to a single parameter or set of related parameters. Such apps, for example, may use artificial intelligence or machine learning based on a set type of data for prediction or classifying a specific output.

For example, U.S. Provisional Application No. 63/209,564 (filed on Jun. 11, 2021), having the title “DIGITAL IMAGING ANALYSIS OF BIOLOGICAL FEATURES DETECTED IN PHYSICAL MEDIUMS,” and U.S. Non-provisional application Ser. No. 17/835,008 (filed on Jun. 8, 2022) and having the same title, which are incorporated by reference in their entirety herein, describe biological digital imaging systems and methods for analyzing pixel data of one or more digital images depicting absorbent articles or portions of absorbent articles. Such biological digital imaging systems and methods provide a digital imaging based solutions for overcoming problems that arise from the difficulties in identifying and treating various health or safety issues related to bowel movements (BM), urination, or other such digestive track issues of a specific infant or individual.

As another example, U.S. Provisional Application No. 63/216,236 (filed on Jun. 29, 2021), having the title “SYSTEMS AND METHODS FOR GENERATING ENHANCED 3D IMAGES OF INFANTS AND DETERMINING RESPECTIVE DIAPER FIT RECOMMENDATIONS,” which is incorporated by reference in its entirety herein, describes 3D image modeling systems and methods for determining respective mid-section dimensions of individuals, e.g., including by way of non-limiting example, any of infants, young children, or other individuals. Such 3D image modeling systems and methods provide a digital imaging based solutions for overcoming problems that arise from correctly identifying dimensions of an infant. For example, the 3D image modeling systems and methods described herein may be used to accurately determine a waist dimension, a leg dimension, and/or a rise dimension of an individual (e.g., infant).

As a still further example, U.S. Provisional Application No. 63/350,466 (filed on Jun. 9, 2022), having the title “ARTIFICIAL INTELLIGENCE BASED SYSTEM AND METHODS FOR PREDICTING SKIN ANALYTICS OF INDIVIDUALS,” which is incorporated by reference in its entirety herein, describes digital imaging systems and methods for analyzing pixel data of at least one image of a diaper change region associated with an individual for determining an individual-specific diaper change region skin characteristic, e.g., including by way of non-limiting example, any of infants, young children, or other individuals. Such digital imaging systems and methods provide a digital imaging and artificial intelligence (AI) based solution for overcoming skin conditions and/or skin concerns that arise in individuals who wear absorbent articles, such as diapers. For example, the digital imaging systems and methods described herein may be used to accurately identify, based on pixel data of other individuals, an individual-specific diaper change region skin characteristic and may provide an individual-specific electronic recommendation designed to address at least one feature identifiable within the pixel data of a specific individual's diaper change region.

However, while such apps are useful and provide technical solutions designed to address their respective tasks, such apps can be limited in their ability to leverage data and learnings from each other to provide informed product recommendations and user-specific predictions regarding normalcy, growth, and development insights, and/or other technical solutions based on a more holistic app dataset produced from users across the various apps.

For the foregoing reasons, there is a need for AI based multi-app systems and methods for predicting user-specific events and/or characteristics and generating user-specific recommendations based on app usage.

### SUMMARY

As described herein, AI based multi-app systems and methods are configured to predict user-specific events and/or characteristics. The AI based multi-app systems and methods may further be configured to generate user-specific recommendations based on app usage. More generally, the disclosure herein relates to an app ecosystem that enables and uses predictive outputs of AI or machine learning (including learning over time) combined to offer more informed insights as to normalcy, growth, and development. The combined learnings may also be used to provide predictive insights. By way of non-limiting example, predictive insights may be based on, in some aspects, body composition, urine, stool make-up and/or consistency of a user over time. By monitoring such user information, which may comprise predictive outputs of apps and app usage data, the app ecosystem can predict future event(s) and/or characteristic(s) of specific users or individuals. The predicted future event(s) and/or characteristic(s) may comprise transitions in growth states, timing and introduction of new foods, skin health condition (including issues or improvements), toilet training readiness, and/or other aspects specific to one or more users or individuals.

In various aspects, an ensemble AI model may be trained to output a user-specific electronic recommendation(s) designed to address predicted event(s) and/or characteristic(s). By analyzing previous outputs of existing apps and/or app usage data of multiple users using multiple apps, an ensemble AI model may be trained or executed, with such outputs or data, to provide improved recommendation(s) for specific consumers, including specific and targeted predications of growth, development, normalcy, or the like. For example, such user-specific electronic recommendation(s) may comprise product recommendation(s) based on prediction of transition of growth states. For example, customized product recommendation(s) can be recommended and/or shipped and can correspond to the prediction of a user's advancement to a next stage of development. Such customized products recommendations may be based on unique attributes like size, form (e.g., diaper or pant), design features of products (e.g., top-sheets, fasteners, or the like for a diaper for a given stage of development), and/or ingredients (e.g., lotion formulations for unique skin needs, specialized ingredients based on specific diets to neutralize fecal enzymes, or the like). Additionally, or alternatively, user-specific electronic recommendation(s) may comprise report(s) of a user or individual (e.g., a baby or infant) to be sent or transmitted to pediatrician or parent automatically.

More specifically, as describe herein, an artificial intelligence (AI) based multi-application (app) method is disclosed. The AI based multi-app method may comprise aggregating, at one or more processors communicatively coupled to one or more memories, a training data set comprising a plurality of previous predictive outputs of multiple existing AI apps, the previous predictive outputs comprising respective predictions or classifications associated with activities or product usage of respective users. The AI based multi-app method may further comprise training, by the one or more processors with the plurality of predictive outputs, an ensemble AI model operable to predict events and/or characteristics of respective users; receiving, at the one or more processors, app usage data associated with a user interacting with an app, wherein the app is selected from the multiple existing AI apps. The AI based multi-app method may further comprise analyzing, by the ensemble AI model executing on the one or more processors, the app usage data to determine a predicted event and/or characteristic of the user. The AI based multi-app method may further comprise generating, by the one or more processors based on the predicted event and/or characteristic of the user, at least one user-specific electronic recommendation designed to address the predicted event and/or characteristic. The AI based multi-app method may further comprise rendering, on a display screen of a user computing device, the at least one user-specific recommendation.

In addition, as described herein, an artificial intelligence (AI) based multi-application (app) system is disclosed. The AI based multi-app system is configured to predict user-specific events and/or characteristics and generate user-specific recommendations based on app usage. The AI based multi-app system may comprise a server comprising a server processor and a server memory. The AI based multi-app system may further comprise a multiple app configured to execute on a user computing device comprising a device processor and a device memory. The multiple app may be communicatively coupled to the server, and the multiple app may be configured to launch or access multiple existing AI apps. The AI based multi-app system may further comprise an ensemble AI model trained with a training data set comprising a plurality of previous predictive outputs of the multiple existing AI apps. The previous predictive outputs may comprise respective predictions and/or classifications associated with activities or product usage of respective users. The ensemble AI model may be configured to predict events and/or characteristics of respective users. Computing instructions stored in the server memory may be configured to execute on the server processor or the device processor to cause the server processor or the device processor to: receive, at the one or more processors, app usage data associated with a user interacting with an app, wherein the app is selected from the multiple existing AI apps; analyze, by the ensemble AI model executing on the one or more processors, the app usage data to determine a predicted event and/or characteristic of the user; generate, by the one or more processors based on the predicted event and/or characteristic of the user, at least one user-specific electronic recommendation designed to address the predicted event and/or characteristic; and/or render, on a display screen of a user computing device, the at least one user-specific recommendation.

Further, as described herein, a tangible, non-transitory computer-readable medium storing instructions for predicting user-specific events and/or characteristics and generating user-specific recommendations based on app usage is disclosed. The instructions, when executed by one or more processors may cause the one or more processors to: aggregate a training data set comprising a plurality of previous predictive outputs of multiple existing AI apps, the previous predictive outputs comprising respective predictions or classifications associated with activities or product usage of respective users; train, with the plurality of predictive outputs, an ensemble AI model operable to predict events and/or characteristics of respective users; receive app usage data associated with a user interacting with an app, wherein the app is selected from the multiple existing AI apps; analyze, by the ensemble AI model, the app usage data to determine a predicted event and/or characteristic of the user; generate, based on the predicted event and/or characteristic of the user, at least one user-specific electronic recommendation designed to address the predicted event and/or characteristic; and/or render, on a display screen of a user computing device, the at least one user-specific recommendation.

In accordance with the above, and with the disclosure herein, the present disclosure includes improvements in computer functionality or in improvements to other technologies at least because the disclosure describes that, e.g., a server, or otherwise computing device (e.g., a user computer device), is improved where the intelligence or predictive ability of the imaging server or computing device is enhanced by a trained (e.g., machine learning trained) ensemble AI model. The ensemble AI model, executing on the server or computing device, is able to accurately identify, based on previous predictive outputs of multiple existing AI apps and/or app usage data, user-specific electronic recommendation designed to address the predicted event and/or characteristic. That is, the present disclosure describes improvements in the functioning of the computer itself or “any other technology or technical field” because an server or user computing device is enhanced with a plurality of predictive outputs of multiple existing AI apps and/or app usage data to accurately predict, detect, or determine user-specific electronic recommendation designed to address the predicted event and/or characteristic. This improves over the prior art at least because existing systems lack such predictive or classification functionality and are simply not capable of accurately analyzing predictive outputs of multiple existing AI apps and/or app usage data to output a predictive result designed to address the predicted event and/or characteristic.

In addition, the present disclosure relates to improvement to other technologies or technical fields at least because the present disclosure describes or introduces improvements to computing devices in field of artificial intelligence and, in particular, detecting user-specific electronic recommendation designed to address the predicted event and/or characteristic for specific users based on specific user data and/or output of a specific user's apps as used by the user.

In addition, an ensemble AI model, executing on an underlying computer device, improves the underlying computer device (e.g., server(s) and/or user computing device), where such computer device(s) are made more efficient by the configuration, adjustment, or adaptation of a given machine-learning network architecture. For example, in some aspects, fewer machine resources (e.g., processing cycles or memory storage) may be used by decreasing computational resources by decreasing machine-learning network architecture needed to analyze predictive outputs of multiple existing AI apps and/or app usage data, including by reducing depth, width, image size, or other machine-learning based dimensionality requirements. Reduction may be achieved, for example, by updating the ensemble AI model overtime, where an ensemble AI model need not be trained on an extremely large dataset at once. Such reduction frees up the computational resources of an underlying computing system, thereby making it more efficient.

Still further, the present disclosure relates to improvement to other technologies or technical fields at least because the present disclosure describes or introduces improvements to computing devices in the field of security and/or image processing, where, at least in some aspects, predictive outputs of multiple existing AI apps, data, and/or images of users may be preprocessed (e.g., cropped or otherwise modified) to define extracted or reduced data removing personal identifiable information (PII) of a user or individual. For example, deleted, cropped, and/or redacted portions of data and/or images may be used by the ensemble AI model described herein, which eliminates the need of transmission of private data and/or images of individuals across a computer network (where such images may be susceptible of interception by third parties). Such features provide a security improvement, i.e., where the removal or deletion of PII provides an improvement over prior systems because cropped, redacted, and/or redacted data and/or images, especially ones that may be transmitted over a network (e.g., the Internet), are more secure without including PII information of an individual. Such system may allow for predictions or determinations as described herein without PII of the individual. Accordingly, the systems and methods described herein operate without the need for such information, which provides an improvement, e.g., a security improvement, over prior system. In addition, the use of redacted and/or cropped images and/or data, at least in some aspects, allows the underlying system to store and/or process smaller data amounts, which results in a performance increase to the underlying system as a whole because the smaller data size requires less storage memory and/or processing resources to store, process, and/or otherwise manipulate by an underlying computer system.

In addition, the present disclosure includes specific features other than what is well-understood, routine, conventional activity in the field, or adds unconventional steps that confine the claim to a particular useful application, e.g., AI based multi-app systems and methods for predicting user-specific events and/or characteristics and generating user-specific recommendations based on app usage.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates an example artificial intelligence (AI) based multi-application (app) system configured to predict user-specific events and/or characteristics and generate user-specific recommendations based on app usage, in accordance with various embodiments disclosed herein.

FIG. 2 illustrates an artificial intelligence (AI) based multi-application (app) method for predicting user-specific events and/or characteristics and generating user-specific recommendations based on app usage, in accordance with various embodiments disclosed herein.

FIG. 3A illustrates an example graphic user interface of the multi-app system of FIG. 1 and the multi-app method of FIG.2, where the graphic user interface is rendered on a display screen of a user computing device in accordance with various embodiments disclosed herein.

FIG. 3B further illustrates an example graphic user interface of the multi-app system of FIG. 1 and the multi-app method of FIG.2, where the graphic user interface is rendered on a display screen of a user computing device in accordance with various embodiments disclosed herein.

FIG. 3C further illustrates an example graphic user interface of the multi-app system of FIG. 1 and the multi-app method of FIG.2, where the graphic user interface is rendered on a display screen of a user computing device in accordance with various embodiments disclosed herein.

FIG. 3D further illustrates an example graphic user interface of the multi-app system of FIG. 1 and the multi-app method of FIG.2, where the graphic user interface is rendered on a display screen of a user computing device in accordance with various embodiments disclosed herein.

FIG. 3E further illustrates an example graphic user interface of the multi-app system of FIG. 1 and the multi-app method of FIG.2, where the graphic user interface is rendered on a display screen of a user computing device in accordance with various embodiments disclosed herein.

FIG. 3F further illustrates an example graphic user interface of the multi-app system of FIG. 1 and the multi-app method of FIG.2, where the graphic user interface is rendered on a display screen of a user computing device in accordance with various embodiments disclosed herein.

FIG. 3G further illustrates an example graphic user interface of the multi-app system of FIG. 1 and the multi-app method of FIG.2, where the graphic user interface is rendered on a display screen of a user computing device in accordance with various embodiments disclosed herein.

FIG. 3H further illustrates an example graphic user interface of the multi-app system of FIG. 1 and the multi-app method of FIG.2, where the graphic user interface is rendered on a display screen of a user computing device in accordance with various embodiments disclosed herein.

The Figures depict preferred embodiments for purposes of illustration only. Alternative embodiments of the systems and methods illustrated herein may be employed without departing from the principles of the invention described herein.

### DETAILED DESCRIPTION OF THE INVENTION

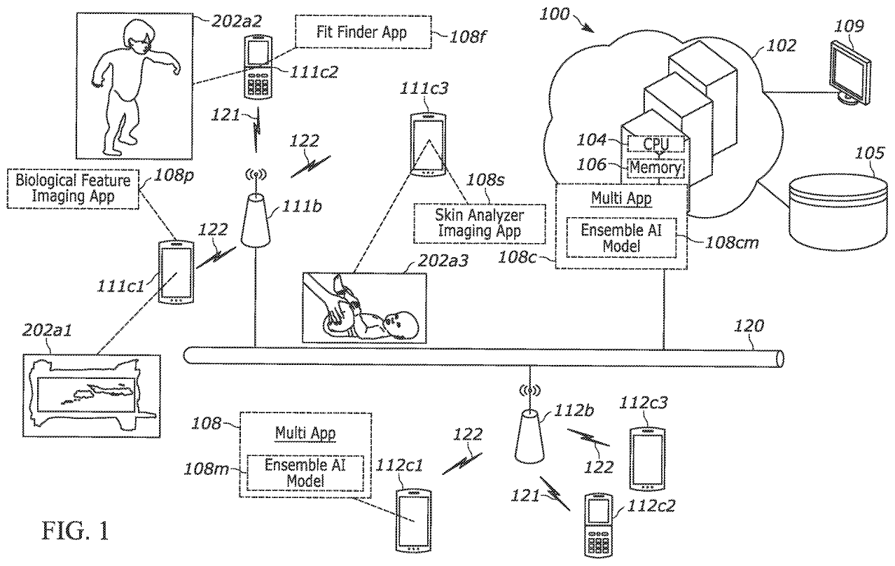

FIG. 1 illustrates an example artificial intelligence (AI) based multi-application (app) system 100 configured to predict user-specific events and/or characteristics and generate user-specific recommendations based on app usage, in accordance with various embodiments disclosed herein. In the example embodiment of FIG. 1, AI based multi-app system 100 includes server(s) 102, which may comprise one or more computer servers. In various embodiments server(s) 102 comprise multiple servers, which may comprise a multiple, redundant, or replicated servers as part of a server farm. In still further embodiments, server(s) 102 may be implemented as cloud-based servers, such as a cloud-based computing platform. For example, server(s) 102 may be any one or more cloud-based platform(s) such as MICROSOFT AZURE, AMAZON AWS, or the like. Server(s) 102 may include one or more processor(s) 104 as well as one or more computer memory(ies) 106.

The memory(ies) 106 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory(ies) 106 may store an operating system (OS) (e.g., Microsoft Windows, Linux, UNIX, etc.) capable of facilitating the functionalities, apps, methods, or other software as discussed herein. The memory(ies) 106 may also store a multiple (multi) application (app) 108c designed to communicate with multiple applications app such as, for example, a fit finder app (e.g., fit finder app 108f), a biological feature imaging app (e.g., biological feature imaging app 108p), and a skin analyzer imaging app (e.g., skin analyzer imaging app 108s). Multi app 108c may comprise a server-side application, or application portion designed for execution on server(s) 102. Multi app 108 may comprise a client-side application, or application portion, designed for execution on a user computing device (e.g., user computing device 112c1). The Multi app 108c (on server 102) or multi app 108 of a user computing device is configured to launch or access the multiple existing AI apps (e.g., fit finder app 108f, biological feature imaging app 108p, and/or skin analyzer imaging app 108s). In various aspects, Multi App 108c may be configured to communicate with, access, or otherwise interface with multiple applications that operate or execute at either a user computing device (e.g., a client device) and/or one or more server(s), where, for example in FIG. 1, any one or more of the finder app 108f, biological feature imaging app 108p, and/or skin analyzer imaging app 108s may have client and/or server code that communicates with, accesses, or otherwise interfaces with Multi App 108c and/or multi app 108, in order to implement or execute the systems and/or methods described herein. Still further, multi app 108c and/or multi app 108 may comprise an ensemble AI model (e.g., ensemble AI model 108cm and/or ensemble AI model 108m, respectively), which may be an artificial intelligence based model, such as a machine learning model, trained on predictive outputs of multiple existing AI apps, images (e.g., images 202a1, 202a2, and/or 202a3), and/or data (e.g., medical data, parental data, sensor data, log data, and/or user-specific growth data), as described herein. Training data be stored in memory(ies) 106 and/or database 105, which is accessible or otherwise communicatively coupled to server(s) 102. The memory(ies) 106 may also store machine readable instructions, including any of one or more application(s), one or more software component(s), and/or one or more application programming interfaces (APIs), which may be implemented to facilitate or perform the features, functions, and/or other disclosure described herein, such as any methods, processes, elements, or limitations, as illustrated, depicted, or described for the various flowcharts, illustrations, diagrams, figures, and/or other disclosure herein. For example, at least some of the applications, software components, or APIs, such as multi app 108c and/or multi app 108, may be, include, otherwise comprise, a machine learning model or component, such as the ensemble AI model (e.g., ensemble AI model 108cm and/or ensemble AI model 108m) where each may be configured to facilitate their various functionalities discussed herein. It should be appreciated that the one or more other applications or AI models may be executed by the processor(s) 104 and/or processors on a user computing device (e.g., user computing device 112c1).

The processor(s) 104 may be connected to the memory(ies) 106 via a computer bus responsible for transmitting electronic data, data packets, or otherwise electronic signals to and from the processor(s) 104 and memory(ies) 106 in order to implement or perform the machine readable instructions, methods, processes, elements or limitations, as illustrated, depicted, or described for the various flowcharts, illustrations, diagrams, figures, and/or other disclosure herein.

The processor(s) 104 may interface with the memory(ies) 106 via the computer bus to execute the operating system (OS). The processor(s) 104 may also interface with the memory 106 via the computer bus to create, read, update, delete, or otherwise access or interact with the data stored in the memories 106 and/or the database 105 (e.g., a relational database, such as Oracle, DB2, MySQL, or a NoSQL based database, such as MongoDB). The data stored in the memory(ies) 106 and/or the database 105 may include all or part of any of the data or information described herein, including, for example, predictive outputs of multiple existing AI apps, app usage data, training images and/or user images (e.g., either of which including any one or more of images 202a, 202b, and/or 202c) and/or other data or information of the user, including medical data, parental data, sensor data, log data, and/or user-specific growth data, or the like.

The server(s) 102 may further include a communication component configured to communicate (e.g., send and receive) data via one or more external/network port(s) to one or more networks or local terminals, such as computer network 120 and/or terminal 109 (for rendering or visualizing) described herein. In some embodiments, server(s) 102 may include a client-server platform technology such as ASP.NET, Java J2EE, Ruby on Rails, Node.js, a web service or online API, responsive for receiving and responding to electronic requests. The server(s) 102 may implement the client-server platform technology that may interact, via the computer bus, with the memory(ies) 106 (including the applications(s), component(s), API(s), data, etc. stored therein) and/or database 105 to implement or perform the machine readable instructions, methods, processes, elements, or limitations, as illustrated, depicted, or described for the various flowcharts, illustrations, diagrams, figures, and/or other disclosure herein. According to some embodiments, the server(s) 102 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to computer network 120. In some embodiments, computer network 120 may comprise a private network or local area network (LAN). Additionally, or alternatively, computer network 120 may comprise a public network such as the Internet.

Server(s) 102 may further include or implement an operator interface configured to present information to an administrator or operator and/or receive inputs from the administrator or operator. As shown in FIG. 1, an operator interface may provide a display screen (e.g., via terminal 109). Server(s) 102 may also provide I/O components (e.g., ports, capacitive or resistive touch sensitive input panels, keys, buttons, lights, LEDs), which may be directly accessible via or attached to server(s) 102 or may be indirectly accessible via or attached to terminal 109. According to some embodiments, an administrator or operator may access the server 102 via terminal 109 to review information, make changes, input training data or images, and/or perform other functions.

As described above herein, in some embodiments, server(s) 102 may perform the functionalities as discussed herein as part of a “cloud” network or may otherwise communicate with other hardware or software components within the cloud to send, retrieve, or otherwise analyze data or information described herein.

In general, a computer program or computer based product, application, or code (e.g., the model(s), such as AI models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 104 (e.g., working in connection with the respective operating system in memories 106) to facilitate, implement, or perform the machine readable instructions, methods, processes, elements, or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

As shown in FIG. 1, server(s) 102 are communicatively connected, via computer network 120, to the one or more user computing devices 111c1-111c3 and/or 112c1-112c3 via base stations 111b and 112b. In some embodiments, base stations 111b and 112b may comprise cellular base stations, such as cell towers, communicating to the one or more user computing devices 111c1-111c3 and 112c1-112c3 via wireless communications 121 based on any one or more of various mobile phone standards, including NMT, GSM, CDMA, UMMTS, LTE, 5G, or the like. Additionally, or alternatively, base stations 111b and 112b may comprise routers, wireless switches, or other such wireless connection points communicating to the one or more user computing devices 111c1-111c3 and 112c1-112c3 via wireless communications 122 based on any one or more of various wireless standards, including by non-limiting example, IEEE 802.11a/b/c/g (WIFI), the BLUETOOTH standard, or the like.

Any of the one or more user computing devices 111c1-111c3 and/or 112c1-112c3 may comprise mobile devices and/or client devices for accessing and/or communications with server(s) 102. In various embodiments, user computing devices 111c1-111c3 and/or 112c1-112c3 may comprise a cellular phone, a mobile phone, a tablet device, a personal data assistance (PDA), or the like, including, by non-limiting example, an APPLE iPhone or iPad device or a GOOGLE ANDROID based mobile phone or table. In still further embodiments, user computing devices 111c1-111c3 and/or 112c1-112c3 may comprise a home assistant device and/or personal assistant device, e.g., having display screens, including, by way of non-limiting example, any one or more of a GOOGLE HOME device, an AMAZON ALEXA device, an ECHO SHOW device, or the like.

In addition, the one or more user computing devices 111c1-111c3 and/or 112c1-112c3 may implement or execute an operating system (OS) or mobile platform such as Apple's iOS and/or Google's Android operation system. Any of the one or more user computing devices 111c1-111c3 and/or 112c1-112c3 may comprise one or more processors and/or one or more memories for storing, implementing, or executing computing instructions or code, e.g., a mobile application or a home or personal assistant application, as described in various embodiments herein. As shown in FIG. 1, multi app 108 may also be stored locally on a memory of a user computing device (e.g., user computing device 112c1). In addition, as shown for FIG. 1, other apps such as fit finder app 108f, biological feature imaging app 108p, and skin analyzer imaging app 108s may be stored on the respective memories of any of the user computing devices, including, but not limited to, user computing devices 111c1-111c3 as shown by way of example, in FIG. 1. Additionally, or alternatively, other apps such as fit finder app 108f, biological feature imaging app 108p, and skin analyzer imaging app 108s may be stored on the respective memories of a cloud server, e.g., server(s) 102, including, for example, when such apps are implemented as web applications comprising hyper-text-markup-language (HTML), JavaScript, or other code as served from such cloud server (e.g., server(s) 102).

User computing devices 111c1-111c3 and/or 112c1-112c3 may comprise a wireless transceiver to receive and transmit wireless communications 121 and/or 122 to and from base stations 111b and/or 112b. Predictive outputs of multiple existing AI apps, pixel based images (e.g., such as 202a1, 202a2, and/or 202a3), and/or data (e.g., such as app usage data or medical data, parental data, sensor data, log data, and/or user-specific growth data) may be transmitted via computer network 120 to server(s) 102 for training of model(s) and/or imaging or data analysis as described herein.

In addition, the one or more user computing devices 111c1-111c3 and/or 112c1-112c3 may include a digital camera and/or digital video camera for capturing or taking digital images and/or frames (e.g., which can comprise any one or more of images 202a1, 202a2, and/or 202a3 from the various apps). Each digital image may comprise pixel data for training or implementing model(s), such as AI or machine learning models, as described herein. For example, a digital camera and/or digital video camera of, e.g., any of user computing devices 111c1-111c3 and/or 112c1-112c3, may be configured to take, capture, or otherwise generate digital images (e.g., pixel based images 202a, 202b, and/or 202c) and, at least in some embodiments, may store such images in a memory of a respective user computing devices.

Still further, each of the one or more user computer devices 111c1-111c3 and/or 112c1-112c3 may include a display screen for displaying graphics, images, text, product recommendations, data, pixels, features, and/or other such visualizations, data, and/or information as described herein. In various embodiments, graphics, images, text, product recommendations, data, pixels, features, and/or other such visualizations, data, and/or information may be received from server(s) 102 for display on the display screen of any one or more of user computer devices 111c1-111c3 and/or 112c1-112c3. Additionally, or alternatively, a user computer device may comprise, implement, have access to, render, or otherwise expose, at least in part, an interface or a guided graphic user interface (GUI) for displaying text and/or images on its display screen.

With further reference to FIG. 1, AI based multi-app system 100 may comprise multiple application (app) 108 configured to execute on a user computing device (e.g., user computing device 112c1) comprising a device processor and a device memory. While shown in FIG. 1 as installed on user computing device 112c1, it should be understood that multi app 108 may be installed and may execute on any of the computer devices 111c1-111c3 and/or 112c1-112c3. Multi app 108 may be communicatively coupled to server 102. Multi app 108 may be configured to launch or access the multiple existing AI apps, e.g., fit finder app 108f, biological feature imaging app 108p, and/or skin analyzer imaging app 108s. It should be understood that multiple additional and/or different apps may also be installed, where data, predictions, and/or images from such apps may be transmitted to and from server(s) 102 and any of the computer devices 111c1-111c3 and/or 112c1-112c3.

Multi app 108 and/or multi app 108c may comprise an ensemble AI model (e.g., ensemble AI model 108cm and/or ensemble AI model 108m) trained with a training data set comprising a plurality of previous predictive outputs of multiple existing AI apps (e.g., fit finder app 108f, biological feature imaging app 108p, and/or skin analyzer imaging app 108s). The previous predictive outputs comprise respective predictions or classifications associated with activities or product usage of respective users corresponding to each of the related apps. In particular, predictions or classifications are those of the multiple existing AI apps (e.g., fit finder app 108f, biological feature imaging app 108p, and/or skin analyzer imaging app 108s). In this way, ensemble AI model is trained to, or otherwise configured to, predict events and/or characteristics of respective users based on outputs of otherwise existing AI apps. In this way, the events and/or characteristics may be future expected events based on the user's app usage. The ensemble AI model (e.g., ensemble AI model 108cm and/or ensemble AI model 108m) is configured to execute on a server processor (e.g., processor(s) 104) or a device processor of a user computing device (e.g., user computing device 111c1) for outputting the predictions and/or classifications.

In various embodiments, data maybe collected from user computer devices 111c1-111c3 and/or 112c1-112c3, including from any app, including any one or more of multi app 108, fit finder app 108f, biological feature imaging app 108p, and/or skin analyzer imaging app 108s. In various aspects, the data captured and/or transmitted from multi app 108, fit finder app 108f, biological feature imaging app 108p, and/or skin analyzer imaging app 108s may comprise the predictions or classifications of the multiple existing AI apps.

For example, fit finder app 108f may output or determine a prediction or classification defining a mid-section dimension of an individual based on a fitted 3D model. The output is based on one or more digital images (e.g., digital image 202a2) depicting at least a mid-section portion of the individual. Fit finder app 108f, and its related output, is further described by U.S. Provisional Application No. 63/209,564, filed on Jun. 11, 2021, which is incorporated by reference in its entirety herein.

As a further example, biological feature imaging app 108p may output or determine a prediction or classification defining an individual-specific biological prediction value corresponding to at least one of: (a) an absorbent article; (b) a portion of the absorbent article; or (c) an individual associated with the absorbent article or portion of the absorbent article. The output may be based on digital image(s) (e.g., digital image 202a1) of the absorbent article or the portion of the absorbent article and related pixel data thereof. For example, biological feature imaging app 108p is executed to detect a biological feature depicted within the pixel data of the digital image of the absorbent article or the portion of the absorbent article, and the biological feature is then used to output or determine the prediction or classification. Biological feature imaging app 108p, and its related output, is further described by U.S. Provisional Application No. 63/216,236, filed on Jun. 29, 2021, and U.S. Non-provisional application Ser. No. 17/835,008 filed on Jun. 8, 2022, both of which are incorporated by reference in their entirety herein.

As a still further example, skin analyzer imaging app 108s may output or determine a prediction or classification defining an individual-specific recommendation designed to address at least one feature identifiable within the pixel data of the individual's skin. The output is based on a plurality of training images (e.g., image 202a3) of one or more diaper change regions associated with a respective plurality of individuals. Each of the training images comprise pixel data of a diaper change region associated with a respective individual. Skin analyzer imaging app 108s, and its related output, is further described by U.S. Provisional Application No. 63/350,466, filed on Jun. 9, 2022, which is incorporated by reference in its entirety herein.

In additional aspects, app usage data captured and/or transmitted from multi app 108, fit finder app 108f, biological feature imaging app 108p, skin analyzer imaging app 108s, and/or other app may comprise user selection, user data, and/or image data. For example, images 202a1, 202a2, and/or 202a3 that may be collected or aggregated at server(s) 102 may, in some aspects, be analyzed by, and/or used to train, an enable AI model (e.g., an AI model such as a machine learning imaging model as described herein). Each of these images may comprise pixel data (e.g., RGB data) corresponding to feature data and corresponding to each of the personal attributes of respective users or individuals within the respective image. The pixel data may be captured by a digital camera of one of the user computing devices (e.g., one or more user computer devices 111c1-111c3 and/or 112c1-112c3).

Generally, as described herein, pixel data (e.g., pixel data of images 202a1, 202a2, and/or 202a3) comprises individual points or squares of data within an image, where each point or square represents a single pixel within an image. Each pixel may be a specific location within an image. In addition, each pixel may have a specific color (or lack thereof). Pixel color may be determined by a color format and related channel data associated with a given pixel. For example, a popular color format includes the red-green-blue (RGB) format having red, green, and blue channels. That is, in the RGB format, data of a pixel is represented by three numerical RGB components (Red, Green, Blue), that may be referred to as a channel data, to manipulate the color of pixel's area within the image. In some implementations, the three RGB components may be represented as three 8-bit numbers for each pixel. Three 8-bit bytes (one byte for each of RGB) is used to generate 24 bit color. Each 8-bit RGB component can have 256 possible values, ranging from 0 to 255 (i.e., in the base 2 binary system, an 8 bit byte can contain one of 256 numeric values ranging from 0 to 255). This channel data (R, G, and B) can be assigned a value from 0 255 and be used to set the pixel's color. For example, three values like (250, 165, 0), meaning (Red=250, Green=165, Blue=0), can denote one orange pixel. As a further example, (Red=255, Green=255, Blue=0) means red and green, each fully saturated (255 is as bright as 8 bits can be), with no blue (zero), with the resulting color being yellow. As a still further example, the color black has an RGB value of (Red=0, Green=0, Blue=0) and white has an RGB value of (Red=255, Green=255, Blue=255). Gray has the property of having equal or similar RGB values. So (Red=220, Green=220, Blue=220) is a light gray (near white), and (Red=40, Green=40, Blue=40) is a dark gray (near black).

In this way, the composite of three RGB values creates the final color for a given pixel. With a 24-bit RGB color image using 3 bytes there can be 256 shades of red, and 256 shades of green, and 256 shades of blue. This provides 256×256×256, i.e., 16.7 million possible combinations or colors for 24 bit RGB color images. In this way, the pixel's RGB data value shows how much of each of red, green, and blue pixel is comprised of. The three colors and intensity levels are combined at that image pixel, i.e., at that pixel location on a display screen, to illuminate a display screen at that location with that color. In is to be understood, however, that other bit sizes, having fewer or more bits, e.g., 10-bits, may be used to result in fewer or more overall colors and ranges.

As a whole, the various pixels, positioned together in a grid pattern, form a digital image (e.g., pixel data 202ap, 202bp, and/or 202cp). A single digital image can comprise thousands or millions of pixels. Images can be captured, generated, stored, and/or transmitted in a number of formats, such as JPEG, TIFF, PNG and GIF. These formats use pixels to store represent the image. The pixel data may be used to train a machine learning model, such that new images may be taken as input to the machine learning model, and where a prediction and/or classification may be provided as output based on the pixel data of the given image.

Still further, the data captured by and/or transmitted from multi app 108, fit finder app 108f, biological feature imaging app 108p, skin analyzer imaging app 108s and/or other app may comprise data such as medical data of a user (e.g., patient data, blood test data, medical record data), parental data (e.g., data showing relationships between parent and children), sensor data (e.g., data captured by sensors of devices that may be communicatively coupled to one or more of the apps), log data (e.g., data recorded during use of an app), and/or user-specific growth data (e.g., data comprising events of a user growing or developing from a first need for a first product (e.g., a first diaper size) to a second need for a second product (e.g., a second diaper size)). It is to be understood that additional or different data or app usage data may be captured by and/or transmitted from multi app 108 for training or executing an ensemble AI model.

In various aspects, computing instructions and/or apps executing at the server (e.g., server(s) 102) and/or at a user computing device (e.g., user computing device 112c1) may be communicatively connected for receiving images, data, previous predictive outputs and/or generating user-specific electronic recommendation(s) designed to address predicted event(s) and/or characteristic(s), as described herein. For example, one or more processors (e.g., processor(s) 104) of server(s) 102 may be communicatively coupled to a mobile device (e.g., user computing device 112c1) via a computer network (e.g., computer network 120). In such aspects, an app (e.g., multi app) may comprise a server app portion (e.g., multi app 108c) configured to execute on the one or more processors of the server (e.g., server(s) 102) and a mobile app portion (e.g., multi app 108) configured to execute on one or more processors of the mobile device (e.g., any of one or more user computing devices 111c1-111c3 and/or 112c1-112c3). In such aspects, the server app portion is configured to communicate with the mobile app portion. The server app portion or the mobile app portion may each be configured to implement, or partially implement, one or more of: (1) aggregating, at one or more processors communicatively coupled to one or more memories, a training data set comprising a plurality of previous predictive outputs of multiple existing AI apps, the previous predictive outputs comprising respective predictions or classifications associated with activities or product usage of respective users; (2) training, by the one or more processors with the plurality of predictive outputs, an ensemble AI model operable to predict events and/or characteristics of respective users; (3) receiving, at the one or more processors, app usage data associated with a user interacting with an app, wherein the app is selected from the multiple existing AI apps; (4) analyzing, by the ensemble AI model executing on the one or more processors, the app usage data to determine a predicted event and/or characteristic of the user; (5) generating, by the one or more processors based on the predicted event and/or characteristic of the user, at least one user-specific electronic recommendation designed to address the predicted event and/or characteristic; and/or (6) rendering, on a display screen of a user computing device, the at least one user-specific recommendation.

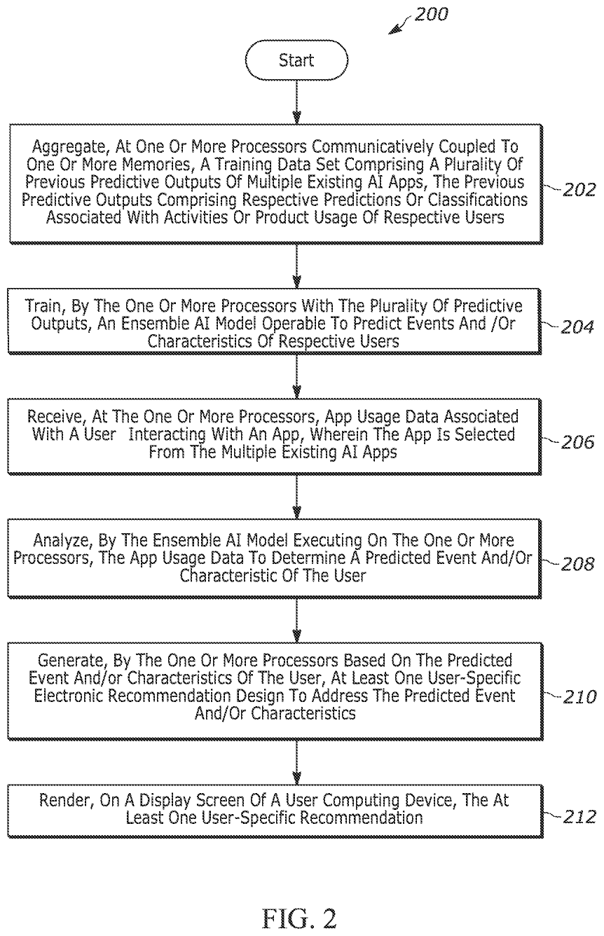

FIG. 2 illustrates an artificial intelligence (AI) based multi-application (app) method 200 for predicting user-specific events and/or characteristics and generating user-specific recommendations based on app usage, in accordance with various embodiments disclosed herein.

At block 202, method 200 comprises aggregating, at one or more processors (e.g., processor(s) 104) communicatively coupled to one or more memories (e.g., memory(ies) 106), a training data set comprising a plurality of previous predictive outputs of multiple existing AI apps. Examples of existing AI apps may comprise one or more of: a fit finder app (e.g., fit finder app 108f), a biological feature imaging app (e.g., biological feature imaging app 108p), a skin analyzer imaging app (e.g., skin analyzer imaging app 108s). It should be understood, however, that additional and/or different apps, collecting additional or different data and/or outputting additional or different predictions and/or classifications, may be used.

Previous predictive outputs may comprise respective predictions and/or classifications associated with activities or product usage of respective users. For example, fit finder app 108f may output or determine a prediction or classification defining a mid-section dimension of an individual based on a fitted 3D model executed or otherwise implemented by fit finder app 108f. The output may be based on one or more digital images (e.g., digital image 202a2) depicting at least a mid-section portion of the individual. The predicted or classified mid-section dimension of an individual may be used to determine an absorbent article (e.g., a diaper) size or fit for the individual.

As another example, biological feature imaging app 108p may output or determine a prediction or classification defining an individual-specific biological prediction value corresponding to at least one of: (a) an absorbent article (e.g., a diaper); (b) a portion of the absorbent article; or (c) an individual associated with the absorbent article or portion of the absorbent article. The output may be based on digital image(s) (e.g., digital image 202a1) of the absorbent article or the portion of the absorbent article and related pixel data thereof. For example, biological feature imaging app 108p is executed to detect a biological feature (e.g., urine or bowel movement features) depicted within the pixel data of the digital image of the absorbent article or the portion of the absorbent article. The biological feature may then be used to output or determine the prediction or classification, e.g., whether the biological feature relates to urine or whether the biological feature relates to a bowel movement having a particular consistency type, e.g., with mucous, with curds, runny, soft, pasty, and/or hard consistency type.

As a still further example, skin analyzer imaging app 108s may output or determine a prediction or classification defining an individual-specific recommendation designed to address at least one feature identifiable within the pixel data of the individual's skin. The output is based on a plurality of training images (e.g., image 202a3) of one or more diaper change regions associated with a respective plurality of individuals. Each of the training images comprise pixel data of a diaper change region associated with a respective individual. The output of the prediction or classification defining an individual-specific recommendation may comprise a recommendation to use a mobile device application, a recommendation to practice one or more procedures associated with the diaper change region, a recommendation to seek or receive healthcare related to the diaper change region, a recommendation of a lifestyle change related to the diaper change region, and/or a recommendation for a visit with a healthcare provider.

It is to be understood that the predictive outputs comprising respective predictions and/or classifications associated with activities or product usage of respective users may be aggregated, collected, and/or received from different and/or additional apps than those of fit finder app 108f, biological feature imaging app 108p, and/or skin analyzer imaging app 108s, where these apps are described herein as non-limiting examples. Additional and/or different apps and related data outputs may also be used.

With further reference to FIG. 2, at block 204, method 200 comprises training, by the one or more processors (e.g., processor(s) 104) with the plurality of predictive outputs, an ensemble AI model operable to predict events and/or characteristics of respective users. In various aspects, the ensemble AI model may comprise a stacked AI model that uses AI stacking. Generally, AI stacking, also known as stacked generalization, comprises generating an ensemble AI model where outputs of existing AI models are used as inputs for training a new machine learning model. With respect to the present disclosure, the predictive outputs comprising respective predictions and/or classifications of multiple existing AI apps (e.g., outputs of fit finder app 108f, biological feature imaging app 108p, and/or skin analyzer imaging app 108s) are used as a training data set to train an ensemble AI model (e.g., ensemble AI model 108cm and/or ensemble AI model 108m). That is, the outputs of the multiple existing AI apps (e.g., outputs of fit finder app 108f, biological feature imaging app 108p, and/or skin analyzer imaging app 108s) are aggregated or combined (e.g., in a database and/or memory, such as database 105 and/or memory 106) to comprise an initial training dataset. The initial training dataset is then as input for training the ensemble AI model (e.g., ensemble AI model 108cm and/or ensemble AI model 108m).

In some embodiments, additional data may be added to the initial training dataset, where the predictive outputs of the existing AI models are combined with other data for training the ensemble model. In such aspects, the ensemble AI model may be further trained on one or more additional data sets selected from: medical data, parental data, sensor data, log data, and/or user-specific growth data. Non-limiting examples of additional data or datasets that could be added to, or combined with, the initial training dataset comprising output predictions, may include data from a doctor of a user (e.g., illness or diagnosis data), charted data by a parent user or a daycare facility, log data regarding growth data and/or feeding of an infant, and/or measured data by a sensor. Sensor data may include, by way of non-limiting example, sensor data collected during seasonal trends or temperature and/or humidity info by temperature and/or humidity sensor(s), sensor data collected from a sensor in a training toilet and/or in or attached to an absorbent article.

In various aspects, the ensemble AI model may be trained on server(s) 102. For example, in such aspects processor(s) of a server or a cloud-based computing platform (e.g., processor(s) 104 of server(s) 102) may receive an initial training data set comprising the plurality of previous predictive outputs of the multiple existing AI apps (e.g., fit finder app 108f, biological feature imaging app 108p, skin analyzer imaging app 108s, and/or other app). In such aspects, the server or the cloud-based computing platform (e.g., server(s) 102) trains the ensemble AI model (e.g., ensemble AI model 108cm and/or ensemble AI model 108m) with the previous predictive outputs of the multiple existing AI apps. The ensemble AI model may be stored in a memory at server(s) 102, such as ensemble AI model 108cm in memory 106. Additionally, or alternatively, the ensemble AI model may be stored in a memory of a user computing device, such ensemble AI model 108m in memory of user computing device 112c1 when the multi app 108 is downloaded or otherwise installed or implemented on user computing device 112c1. In various aspects, ensemble AI model 108cm and ensemble AI model 108m may comprise copies of a same ensemble AI model, but be installed and executed at different locations, e.g., server(s) 102 and user computing device 112c1, respectively.

More generally, a machine learning imaging model, as described herein (e.g., ensemble AI model 108cm and/or ensemble AI model 108m), may be trained using a supervised or unsupervised machine learning program or algorithm. The machine learning program or algorithm may employ a neural network, which may be a convolutional neural network, a deep learning neural network, or a combined learning module or program that learns in two or more features or feature datasets (e.g., pixel data) in particular areas of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques. In some embodiments, the artificial intelligence and/or machine learning based algorithms may be included as a library or package executed on server(s) 102. For example, libraries may include the TENSORFLOW based library, the PYTORCH library, and/or the SCIKIT-LEARN Python library.

Machine learning may involve identifying and recognizing patterns in existing data (such as training a model based on a plurality of previous predictive outputs of multiple existing AI apps and/or other data as described herein) in order to facilitate making predictions or identification for subsequent data (such as using the model on new data of a new individual in order to generate at least one user-specific electronic recommendation designed to address a predicted event and/or characteristic for the individual).

Machine learning model(s), such as the ensemble AI model described herein for some embodiments, may be created and trained based upon example data (e.g., “training data”) inputs or data (which may be termed “features” and “labels”) in order to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based on the discovered rules, relationships, or model, an expected output.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated.

Supervised learning and/or unsupervised machine learning may also comprise retraining, relearning, or otherwise updating models with new, or different, information or data, which may include information received, ingested, generated, or otherwise used over time, and/or which may include information and/or data from difference sources, questionnaires, user feedback, etc. The disclosures herein may use one or both of such supervised or unsupervised machine learning techniques.

With further reference to FIG. 2, at block 206, method 200 comprises receiving, at the one or more processors (e.g., processor(s) 104), app usage data associated with a user interacting with an app, wherein the app is selected from the multiple existing AI apps (e.g., fit finder app 108f, biological feature imaging app 108p, skin analyzer imaging app 108s, and/or other app). Any of the multiple existing AI apps may be launched, opened, or otherwise accessed from a multi app (e.g., multi app 108) as installed on respective device(s) (e.g., any one or more of one or more user computing devices 111c1-111c3 and/or 112c1-112c3) and/or as served from a cloud server, e.g., server(s) 102. In various aspects, the app usage data may comprise data collected while the user is using a given app. Additionally, or alternatively, the app usage data may comprise data as selected by a user. Additionally, or alternatively, app usage data may comprise one or more images (e.g., any one or more of images 202a1, 202a2, and/or 202a3) having pixel data. The one or more images may be collected using a camera, such as a digital camera and/or digital video camera.

At block 208, method 200 comprises analyzing, by the ensemble AI model executing on the one or more processors (e.g., processor(s) 104 or processors of user computing device 112c1), the app usage data to determine a predicted event and/or characteristic of the user.

At block 210, method 200 comprises generating, by the one or more processors (e.g., processor(s) 104 or processors of user computing device 112c1) based on the predicted event and/or characteristic of the user, at least one user-specific electronic recommendation designed to address the predicted event and/or characteristic. By way of non-limiting example, predicted event(s) and/or characteristic(s) of the user may comprise predicted future transitions in growth states and/or stages of the user; predicted future changes in the user's ability to crawl and/or walk; predicted future changes in the user's skin, health, or diet that could lead to a skin rash; predicted future changes in the user's skin, health, or diet that could lead to diaper leaks; predicted future changes in the user's skin, health, or a diet that could lead to skin health condition(s) including issues or improvements; predicted future issues regarding toilet training readiness; and/or predicted timing to move a next size of absorbent article (e.g., diaper), which may be based on a growth and/or development curve, and/or an infant's transition through one or more stages of development and/or growth. It should be understood that these examples are non-limiting and that other predicted event(s) and/or characteristic(s) may be generated or determined for a user or otherwise individual.

At block 212, method 200 comprises rendering, on a display screen of a user computing device (e.g., user computing device 112c1), the at least one user-specific recommendation. In various aspects, the user computing device comprises at least one of a mobile device, a tablet, a handheld device, a desktop device, a home assistant device, a personal assistant device, and/or a retail computing device, for example, as shown and described for FIG. 1.

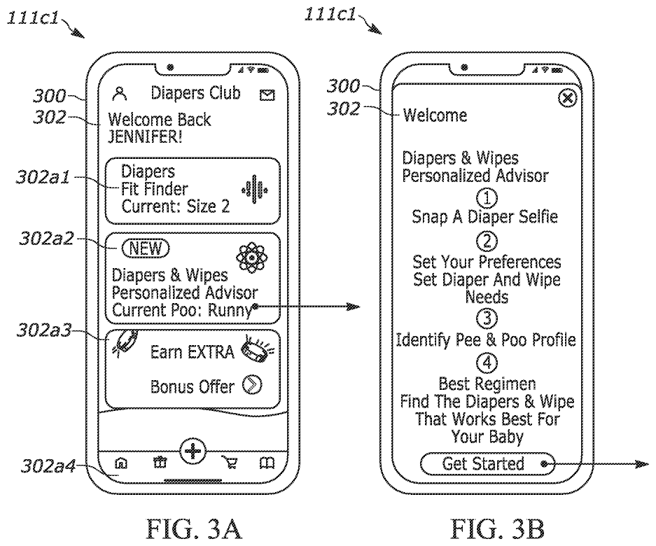

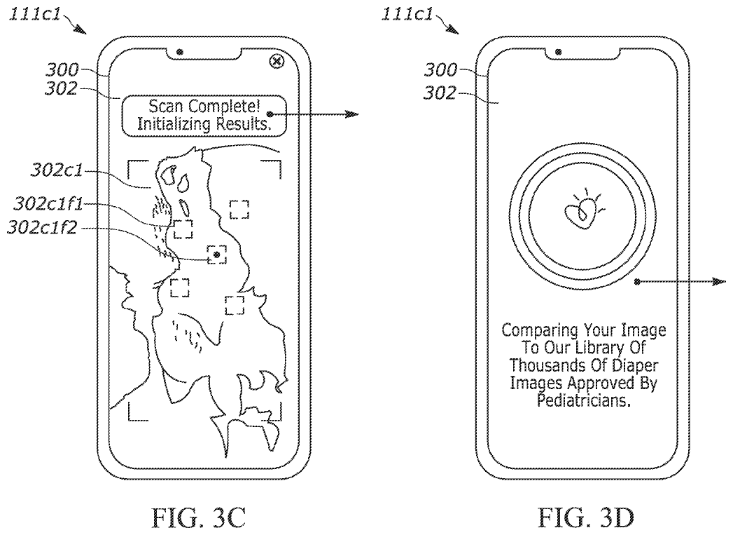

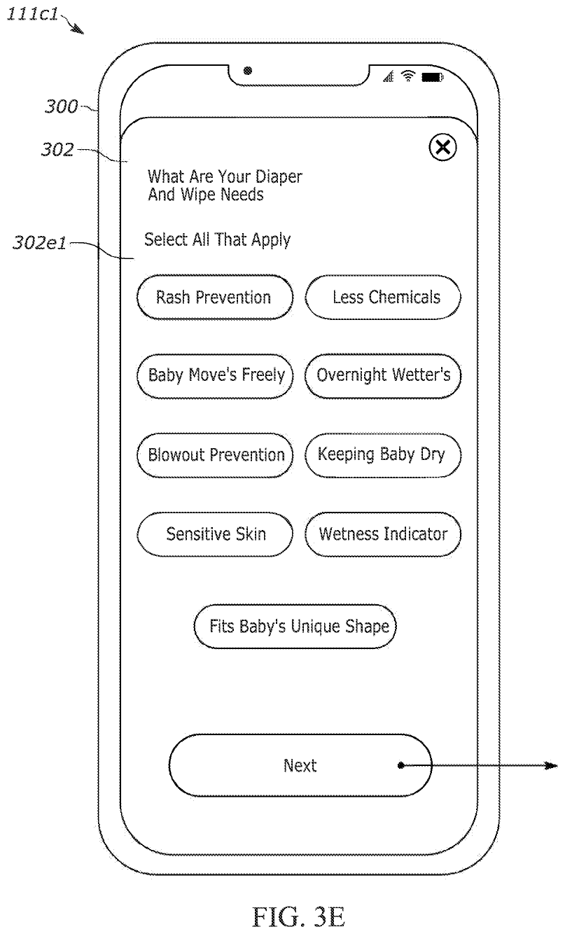

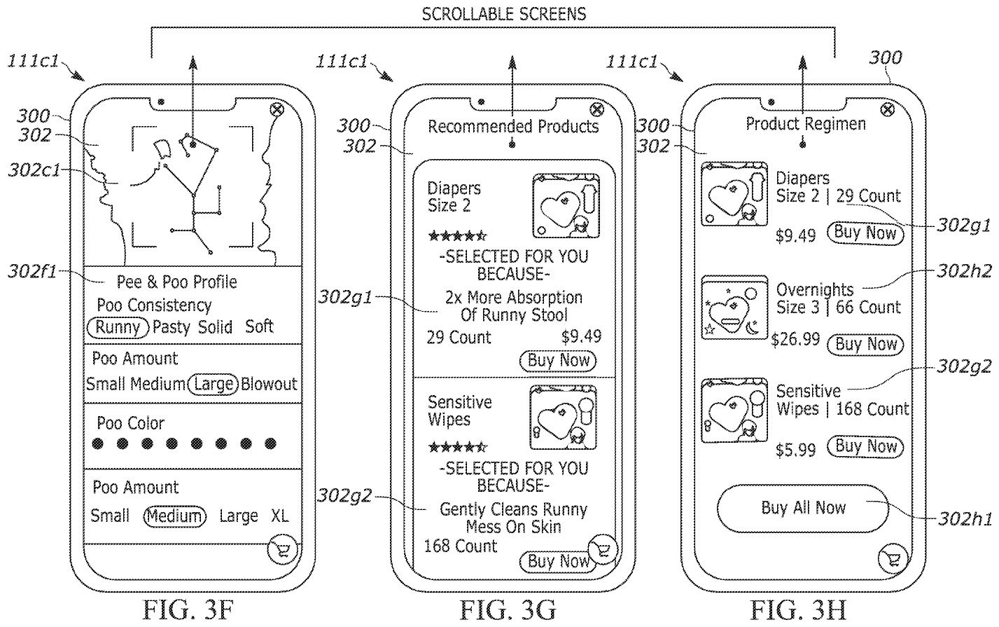

Still further, in various aspects, the user computing device (e.g., user computing device 112c1) may be configured to receive or otherwise collect the app usage data associated with the user. The user computing device (e.g., user computing device 112c1) may then execute the ensemble AI model (e.g., ensemble AI model 108m and/or 108cm) to generate, based on output of the ensemble AI model, the user-specific recommendation. The user-specific recommendation may then be rendered on the display screen of the user computing device, for example, as shown and described herein for FIGS. 3A-3H.

In some aspects, a user computing device (e.g., user computing device 112c1) and server(s) 102 may communicate in order to generate the user-specific recommendation. In such aspects, the server or a cloud-based computing platform (e.g., server(s) 102) receives the app usage data associated with the user. The server or a cloud-based computing platform (e.g., server(s) 102) executes the ensemble AI model (e.g., ensemble AI model 108cm) and generates, based on output of the ensemble AI model (e.g., ensemble AI model 108cm), the user-specific recommendation. The server or a cloud-based computing platform (e.g., server(s) 102) then transmits, via a computer network (e.g., computer network 120), the user-specific recommendation to the user computing device (e.g., computing device 112c1) for rendering on the display screen of the user computing device, for example, as shown and described herein for FIGS. 3A-3H.

Each of FIGS. 3A-3H herein illustrates example graphic user interfaces (GUIs) of the multi-app system of FIG. 1 and the multi-app method of FIG.2, where the GUIs are rendered on a display screen of a user computing device in accordance with various embodiments disclosed herein. The example of FIGS. 3A-3H relates to use of a multi-app (e.g., multi-app 108). More generally, FIGS. 3A-3H illustrates an example graphic user interface 302 as rendered on a display screen 300 of a user computing device 112c1 in accordance with various embodiments disclosed herein. For example, as shown in the examples of FIGS. 3A-3H, graphic user interface 302 may be implemented or rendered via an application (app) executing on user computing device 112c1. Graphic user interface 302 may be implemented or rendered via a native app executing on user computing device (e.g., user computing device 112c1). In the examples of FIGS. 3A-3H, user computing device 112c1 is a user computer device as described for FIG. 1, e.g., where 112c1 is illustrated as an APPLE iPhone that implements the APPLE iOS operating system and has display screen 300. User computing device 112c1 may execute one or more native applications (apps) on its operating system. Such native apps may be implemented or coded (e.g., as computing instructions) in a computing language (e.g., SWIFT) executable by the user computing device operating system (e.g., APPLE iOS) by the processor of user computing device 112c1.

Additionally, or alternatively, graphic user interface 302 may be implemented or rendered via a web interface, such as via a web browser application, e.g., Safari and/or Google Chrome app(s), or other such web browser or the like.

The example of FIGS. 3A-3H relates to use of the multi-app (e.g., multi-app 108) to predict or otherwise determine whether a user or user's child may be transitioning to a different absorbent article (e.g., a diaper) size based on various features, which may indicate a change in diet, growth, or other events and/or characteristics associated with the user or user's child.

FIG. 3A illustrates an example graphic user interface 302 of the multi-app system of FIG. 1 and the multi-app method of FIG.2, where the graphic user interface 302 is rendered on a display screen 302 of a user computing device (e.g., user computer device 112c2) in accordance with various embodiments disclosed herein. GUI 302 of FIG. 3A depicts an example starting or home interface of a multi-app (e.g., multi-app 108) executing on user computing device 112c1. As shown, GUI 302 depicts a user's name (“Jennifer”) and renders several graphic selection options for launching multiple existing AI apps, including graphic selection option 302a1 for launching or otherwise accessing fit finder app 108f and selection option 302a2 for launching or otherwise accessing biological feature imaging app 108p. GUI 302 of FIG. 3A also depicts other graphic selection options, such selection option 302a3 for accessing bonus offers for the user and/or user options 302a4 related to an account of the user. In should be understood that additional and/or different graphic selection options may be displayed for launching additional and/or different apps (e.g., such as skin analyzer imaging app 108s) and/or accessing the user's account and related information thereof, which may comprise medical data, parental data, sensor data, log data, and/or user-specific growth data.

In the example FIG. 3A, GUI 302 is transitioned or is otherwise rendered as shown for FIG. 3B upon the user selecting graphic selection option 302a2 for launching or otherwise accessing biological feature imaging app 108p.

FIG. 3B further illustrates example graphic user interface 302 of the multi-app system of FIG. 1 and the multi-app method of FIG.2, where the graphic user interface 302 is rendered on a display screen 302 of a user computing device (e.g., user computer device 112c2) in accordance with various embodiments disclosed herein. GUI 302 of FIG. 3B depicts a starting or initial interface of biological feature imaging app 108p. The starting or initial interface fit finder app 108f instructs the user as to a series of next steps used to generate, based on predicted event(s) and/or characteristic(s), at least one user-specific electronic recommendation designed to address predicted event(s) and/or characteristic(s) identified by the biological feature imaging app 108p.

In the example FIG. 3B, GUI 302 is transitioned or is otherwise rendered as shown for FIG. 3C upon the user selecting a “Get Started” option from GUI 302 of FIG. 3B.

FIG. 3C further illustrates an example graphic user interface 302 of the multi-app system of FIG. 1 and the multi-app method of FIG.2, where the graphic user interface 302 is rendered on a display screen 302 of a user computing device (e.g., user computer device 112c2) in accordance with various embodiments disclosed herein. GUI 302 of FIG. 3C depicts a screen showing an image 302c1 of an absorbent article depicting various features (e.g., including feature 302c1f1 and feature 302c1f2) that identify bowel movement and/or urine features within image 302c1. The features may be those as identified by biological feature imaging app 108p or as otherwise described for in U.S. Provisional Application No. 63/209,564 (filed on Jun. 11, 2021), having the title “DIGITAL IMAGING ANALYSIS OF BIOLOGICAL FEATURES DETECTED IN PHYSICAL MEDIUMS,” which is incorporated by reference in its entirety herein.

For example, biological feature imaging app 108p, as launched by multi app 108, may generate an individual-specific biological prediction value corresponding to at least one of: (a) an absorbent article (e.g., the absorbent article of image 302c1); (b) a portion of the absorbent article; or (c) an individual (e.g., an infant) associated with the absorbent article or portion of the absorbent article. The individual-specific biological prediction value can be based on biological feature(s) (e.g., feature 302c1f1 and feature 302c1f2 relating to bowel movement and/or urine) depicted within the pixel data of the digital image of the absorbent article or the portion of the absorbent article. The biological feature(s) (e.g., feature 302c1f1 and feature 302c1f2) can predict or otherwise indicate whether urine and/or bowel movement features relate to a given consistency type, e.g., with mucous, with curds, runny, soft, pasty, and/or hard consistency type.

FIG. 3D further illustrates an example graphic user interface 302 of the multi-app system of FIG. 1 and the multi-app method of FIG.2, where the graphic user interface 302 is rendered on a display screen 302 of a user computing device (e.g., user computer device 112c2) in accordance with various embodiments disclosed herein. GUI 302 is transitioned or is otherwise rendered as shown for FIG. 3D when an ensemble AI model (e.g., ensemble AI model 108m and/or ensemble AI model 108cm), executing on the one or more processors (e.g., processor(s) 104 of server(s) 102 and/or a processor of user computing device 112c1), initializes analysis of app usage data (e.g., the absorbent article of image 302c1 depicted for FIG. 3C) to determine a predicted event and/or characteristic of the user. That is, GUI 302 of FIG. 3D depicts a loading or status interface displayed when analysis app usage data is performed. Here the user is using the app to determine biological features of absorbent article of image 302c1 depicted for FIG. 3C. Here the user may be the user or a related user or individuals, such as the user's child, a child in the user's care, and/or otherwise a child associated with the user. It should be noted that the term “user” herein may relate to the user himself or herself or an individual associated with the user (e.g., such as the user's child or child in care of the user).

In the example FIG. 3D, GUI 302 is transitioned or is otherwise rendered as shown for FIG. 3E during and/or upon completion of analysis of app usage data (e.g., the absorbent article of image 302c1 depicted for FIG. 3C) for determining a predicted event and/or characteristic of the user.

FIG. 3E further illustrates an example graphic user interface 302 of the multi-app system of FIG. 1 and the multi-app method of FIG. 2, where the graphic user interface 302 is rendered on a display screen 302 of a user computing device (e.g., user computer device 112c2) in accordance with various embodiments disclosed herein. GUI 302 of FIG. 3E depicts an example set of app usage data, additional app usage data, and/or otherwise data or user data collected in order to determine a predicted event and/or characteristic of the user. For example, as shown for FIG. 3E, a user may select graphical selection option(s) related to the user's identified or perceived diaper and wipe needs, e.g., “rash prevention,” “less chemicals,” “baby move's freely,” “overnight wetter's,” and/or other options as shown for FIG. 3. The app usage data or otherwise data of FIG. 3E may be provided to the ensemble AI model (e.g., ensemble AI model 108m and/or ensemble AI model 108cm), executing on the one or more processors (e.g., processor(s) 104 of server(s) 102 and/or a processor of user computing device 112c1), to initialize analysis of app usage data (e.g., the absorbent article of image 302c1 depicted for FIG. 3C) for determination of a predicted event and/or characteristic of the user. It is to be understood that the graphical selection options of FIG. 3E are non-limiting examples, and that different and/or additional graphical selection options may also be provided for user selection.

In the example FIG. 3E, GUI 302 is transitioned or is otherwise rendered as shown for FIG. 3F-H upon the user selecting the graphical selection option(s) as described for FIG. 3E.

FIGS. 3F-3H further illustrate the example graphic user interface 302 of the multi-app system of FIG. 1 and the multi-app method of FIG.2, where the graphic user interface 302 is rendered on a display screen 302 of a user computing device (e.g., user computer device 112c2) in accordance with various embodiments disclosed herein. GUI 302 of FIG. 3F-3H depict a single scrollable screen and/or a series of one or more screens depicting user-specific electronic recommendation(s) designed to address a predicted event and/or characteristic. In various aspects, the user-specific electronic recommendation is rendered in real-time or near-real time, during, or after the app usage data is received, e.g., at the user computing device 112c1 and/or server(s) 102). Additionally, or alternatively, a user-specific recommendation may be output by a speaker of the user computing device (e.g., user computing device 112c1) as an auditory or verbal recommendation.

For example, as shown in FIG. 3F, the app or otherwise processor(s) described herein may generate, and GUI 302 may render on display screen 300, a predictive output (e.g., predictive output 302f1) indicating that the user or related individual (e.g., a child of the user) has a “runny” stool or bowel movement (“poo”) consistency having a large amount and having a medium amount of urine (“pee”). In various aspects, the predictive output 302f1 may comprise different and/or additional information as shown, e.g., “runny,” “pasty,” “solid,” “soft” for consistency and/or “small,” “medium,” large,” “blowout,” and/or “XL” for amount. It is to be understood that additional and/or different values for a predictive output may be used.

Still further, the ensemble AI model (e.g., ensemble AI model 108m and/or ensemble AI model 108cm), executing on the one or more processors (e.g., processor(s) 104 of server(s) 102 and/or a processor of user computing device 112c1), determines based on analysis of app usage data (e.g., the absorbent article of image 302c1 depicted for FIG. 3C and/or data of FIG. 3E) a predicted event and/or characteristic of the user.

As shown for FIGS. 3G and 3H, the predicted event and/or characteristic of the user or user's individual is sensitive skin of a user (or the user's child) and/or growth of the user (or the user's child) to a size 2 absorbent article (e.g., diapers size 2) and/or size 3 absorbent article (e.g., overnight diapers size 3). It is to be understood that the predicted event(s) and/or characteristic(s) as shown for FIG. 3G and/or 3H are non-limiting examples, and that different and/or additional predicted event(s) and/or characteristic(s) may also be generated, determined, and/or rendered.

In various aspects, a user-specific electronic recommendation may comprise one or more product recommendations for one or more manufactured products. With reference to FIG. 3G, GUI 302 depicts two product recommendations based on, and/or designed to address, a predicted event and/or characteristic (e.g., sensitive skin and/or user growth). As shown, a first product 302g1 that is recommended is an absorbent article product (e.g., a diaper) designed to absorb two times an amount of runny stool. As another example, a second product 302g2 that is recommended is a wipe product (e.g., diaper wipe) designed to clear runny mess on sensitive skin. Both products are based on, and/or designed to address, a predicted event and/or characteristic, where the user has been identified to have sensitive skin and/or have user growth, e.g., where a runny stool may suggest a new diet of a growing user (e.g., an infant or child).

In some aspects, a user-specific electronic recommendation may be displayed on the display screen (e.g., display screen 300) of the user computing device (e.g., user computing device 112c1) with instructions for treating the predicted event and/or characteristic. For example, the depiction of product 302g2 includes instruction(s) for treating sensitive skin, e.g., using the recommended product on sensitive skin to treat runny stools.

In still further aspects, a user-specific electronic recommendation may be displayed on the display screen (e.g., display screen 300) of the user computing device (e.g., user computing device 112c1) with instructions for treating, with the manufactured product, at least one feature identifiable in the app usage data associated with the user where the app usage data comprises pixel data associated with the user. For example, FIG. 3F shows app usage data as pixel data (e.g., features defining runny stool shown) and where FIG. 3G shows instructions for treating, with manufactured product(s), the features defining runny stool. The instructions comprise use of product 302g1 to absorb runny stool (at twice the effectiveness) and use of product 302g2 on the user's identified sensitive skin for cleaning runny stool to prevent skin irritation.

In additional aspects, a modified image based on an image selected from the app usage data may be generated. In such aspects, the modified image may depict a rendering after application of the manufactured product. The modified image may then be rendered, on the display screen (e.g., display screen 300) of the user computing device (e.g., user computing device 112c1). In the example of FIGS. 3F and 3G, a modified image (not shown) may comprise a modified image of 302c1 depicting a diaper that has absorbed more of bowel movement and/or urine (than as shown in an image provided by the user), and therefore depicts a rendering after application of the manufactured product (e.g., product 302g1).

In still further aspects, a user-specific electronic recommendation may be displayed on the display screen (e.g., display screen 300) of the user computing device (e.g., user computing device 112c1) with a graphical representation of the user (or user's child or associated individual) as annotated with one or more graphics or textual renderings corresponding to the user-specific electronic recommendation designed to address the predicted event and/or characteristic of the user. In the example of FIGS. 3F and 3G, a user-specific electronic recommendation may be displayed on the display screen (e.g., display screen 300) of the user computing device (e.g., user computing device 112c1) that shows an image of the user (not shown) having been treated with, or having used, product 302g2 on the user's skin, where the user's skin is shown with annotated imaging showing no or reduced reddening or a rash and/or with annotated text showing areas of the user's skin that would be improved by use of the product 302g2 when applied to sensitive skin.

In additional aspects, conveyance of one or more manufactured products to the user may be initiated based on a product recommendation. For example, as shown for FIG. 3H, a user may initiate, by selecting graphic option selection 302h1, conveyance (e.g., shipment) of manufactured products 302g1, 302h2, and 302g2 to the user, where each product is initiated or otherwise provided based on a product recommendation(s) as described herein for FIGS. 3F and/or 3G. Additionally, or alternatively, conveyance (e.g., shipment) of manufactured products 302g1, 302h2, and 302g2 to the user may be automatically initiated following execution or use of multi app 108 and/or multi app 108c as described herein.

While FIGS. 3A-3H depict one example of this disclosure herein, including analyzing, by an ensemble AI model (e.g., ensemble AI model 108m and/or ensemble AI model 108cm) executing on the one or more processors, app usage data to determine a predicted event and/or characteristic of the user, and generating a user-specific electronic recommendation designed to address the predicted event and/or characteristic, it should be understood that different and/or additional predicted event(s) and/or characteristic(s) may be generated or determined by an ensemble AI model analyzing user app data.

In various aspects, an increasing or growing number or type of new, different, and/or additional predicted outputs of apps and/or app usage data, may be used to train and/or be provided to an ensemble AI model for the purpose of determining new, different, and/or additional predicted event(s) and/or characteristics, for example, in accordance with the disclosure herein.

The predictive outputs of apps and/or app usage data may come from user apps (e.g., a biological feature imaging app, a 3D image modeling systems app, and/or a skin analyzer imaging app) that may be included in, launched from, and/or otherwise accessed from a multi app. New, additional, and/or different apps can produce new, additional, and/or different predictive outputs and/or app usage data that may be used as input to train and/or update an ensemble AI model. Predictive outputs and/or app usage data of new, additional, and/or different apps may comprise apps configured or designed to provide outputs and/or data related to insights and/or benefits of a child's growth stages (e.g., newborn to infant to toddler). Such apps may comprise determinations or output advising of a right and/or best size of a product and/or determination(s) or output(s)advising of right or correct products for one or more users' needs, product form for a user (i.e., diaper versus pant for a user, a diaper change mat to assist with diaper changing for a specific user, a product having a unique underlying structure to product against urine and/or bowel movement discharge for a user, etc.). More generally, determination(s) or output(s) may comprise products predicted based on advancement of a user's next stage (e.g., infant to toddler), and/or determination(s) or output(s) related to a user's normalcy, growth, and/or development that may generated or collected via tracking, and storing in computer memory, images and/or data tracking milestones, such as toilet training readiness or the like.

Such determination(s) or output(s) may be used as input to train an ensemble AI model for the purpose of determining new, different, and/or additional predicted event(s) and/or characteristics. By way of non-limiting example, the predicted event(s) and/or characteristic(s) of the user may comprise predicted future transitions in growth states of the user, predicted future changes in the user's skin, health, or diet that could lead to a skin rash, predicted future changes in the user's skin, health, or diet that could lead to diaper leaks, predicted future changes in the user's skin, health, or diet that could lead to skin health condition(s)n including issues or improvements, predicted future issues regarding toilet training readiness, predicted timing to move a next size of absorbent article (e.g., diaper) and/or a prediction of advancement a next stage, which may be based on a growth and/or development curve, and/or an infant's transition through one or more stages of development and/or growth.

User predicted event(s) and/or characteristics may be used to provide user-specific electronic recommendation(s) designed to address the predicted event and/or characteristic. User-specific electronic recommendation(s) may comprise custom content generated for the user (e.g., custom recommendations and/or education for the user).

For example, user-specific electronic recommendation(s) may come from tracking and collecting user data and app usage data, such as user data of children at daycare facilities or areas, where such data (e.g., app data or other data) may be used to track urine, bowel movement, toilet training milestones, where the user-specific electronic recommendation(s) may relate to which product(s) the user needs and/or is predicted to need at a future time. Additionally, or alternatively, such outputs and/or user data may be added to, and/or combined with, electronic medical health records (e.g., pediatrician records) for implementing telemedicine, where such data may be used to inform a doctor. Such data may also be used as training data or input for an ensemble AI model for generating user-specific electronic recommendation(s) designed to address predicted event(s) and/or characteristic(s) of a user and/or other users (e.g., future users) that use the multi app.

Aspects of the Disclosure

The following aspects are provided as examples in accordance with the disclosure herein and are not intended to limit the scope of the disclosure.

1. An artificial intelligence (AI) based multi-application (app) method for predicting user-specific events and/or characteristics and generating user-specific recommendations based on app usage, the AI based multi-app method comprising: aggregating, at one or more processors communicatively coupled to one or more memories, a training data set comprising a plurality of previous predictive outputs of multiple existing AI apps, the previous predictive outputs comprising respective predictions or classifications associated with activities or product usage of respective users; training, by the one or more processors with the plurality of predictive outputs, an ensemble AI model operable to predict events and/or characteristics of respective users; receiving, at the one or more processors, app usage data associated with a user interacting with an app, wherein the app is selected from the multiple existing AI apps; analyzing, by the ensemble AI model executing on the one or more processors, the app usage data to determine a predicted event and/or characteristic of the user; generating, by the one or more processors based on the predicted event and/or characteristic of the user, at least one user-specific electronic recommendation designed to address the predicted event and/or characteristic; and rendering, on a display screen of a user computing device, the at least one user-specific recommendation.

2. The AI based multi-app method of aspect 1, wherein the at least one user-specific electronic recommendation is displayed on the display screen of the user computing device with a graphical representation of the user as annotated with one or more graphics or textual renderings corresponding to the user-specific electronic recommendation designed to address the predicted event and/or characteristic of the user.

3. The AI based multi-app method of any one of aspects 1-2, wherein the at least one user-specific electronic recommendation is rendered in real-time or near-real time, during, or after the app usage data is received.

4. The AI based multi-app method of any one of aspects 1-3, wherein the at least one user-specific recommendation is output by a speaker of the user computing device as an auditory or verbal recommendation.

5. The AI based multi-app method of any one of aspects 1-4, wherein the at least one user-specific electronic recommendation comprises a product recommendation for a manufactured product.

6. The AI based multi-app method of aspect 5, wherein the at least one user-specific electronic recommendation is displayed on the display screen of the user computing device with instructions for treating, with the manufactured product, the at least one feature identifiable in the app usage data associated with the user, wherein the app usage data comprises pixel data associated with the user.

7. The AI based multi-app method of aspect 5, further comprising the steps of: initiating, based on the product recommendation, the manufactured product for conveyance to the user.

8. The AI based multi-app method of aspect 5, further comprising the steps of: generating, by the one or more processors, a modified image based on an image selected from the app usage data, the modified image depicting a rendering after application of the manufactured product; and rendering, on the display screen of the user computing device, the modified image.

9. The AI based multi-app method of any one of aspects 1-8, wherein the at least one user-specific electronic recommendation is displayed on the display screen of the user computing device with instructions for treating the predicted event and/or characteristic.

10. The AI based multi-app method of any one of aspects 1-9, wherein the multiple existing AI apps comprises one or more of: fit finder app, a biological feature imaging app, a skin analyzer imaging app.

11. The AI based multi-app method of any one of aspects 1-10, wherein the one or more processors comprises at least one of a server or a cloud-based computing platform, and the server or the cloud-based computing platform receives the training data set comprising the plurality of previous predictive outputs of the multiple existing AI apps, and wherein the server or the cloud-based computing platform trains the ensemble AI model with the previous predictive outputs of the multiple existing AI apps.

12. The AI based multi-app method of aspect 11, wherein the server or a cloud-based computing platform receives the app usage data associated with the user, and wherein the server or a cloud-based computing platform executes the ensemble AI model and generates, based on output of the ensemble AI model, the user-specific recommendation and transmits, via a computer network, the user-specific recommendation to the user computing device for rendering on the display screen of the user computing device.

13. The AI based multi-app method of any one of aspects 1-12, wherein the user computing device comprises at least one of a mobile device, a tablet, a handheld device, a desktop device, a home assistant device, a personal assistant device, or a retail computing device.

14. The AI based multi-app method of any one of aspects 1-13, wherein the user computing device receives the app usage data associated with the user, and wherein the user computing device executes the ensemble AI model and generates, based on output of the ensemble AI model, the user-specific recommendation, and renders the user-specific recommendation on the display screen of the user computing device.

15. The AI based multi-app method of any one of aspects 1-14, wherein the app usage data comprises one or more images.

16. The AI based multi-app method of aspect 15, wherein the one or more images are collected using a digital camera.

17. The AI based multi-app method of any one of aspects 1-16, wherein the ensemble AI model is further trained on one or more data sets selected from: medical data, parental data, sensor data, log data, and/or user-specific growth data.

18. An artificial intelligence (AI) based multi-application (app) system configured to predict user-specific events and/or characteristics and generate user-specific recommendations based on app usage, the AI based multi-app system comprising: a server comprising a server processor and a server memory; an multiple application (app) configured to execute on a user computing device comprising a device processor and a device memory, the multiple app communicatively coupled to the server, and the multiple app configured to launch or access multiple existing AI apps; and an ensemble AI model trained with a training data set comprising a plurality of previous predictive outputs of the multiple existing AI apps, the previous predictive outputs comprising respective predictions or classifications associated with activities or product usage of respective users, wherein the ensemble AI model is configured to predict events and/or characteristics of respective users, and wherein computing instructions stored in the server memory are configured to execute on the server processor or the device processor to cause the server processor or the device processor to: receive, at the one or more processors, app usage data associated with a user interacting with an app, wherein the app is selected from the multiple existing AI apps; analyze, by the ensemble AI model executing on the one or more processors, the app usage data to determine a predicted event and/or characteristic of the user; generate, by the one or more processors based on the predicted event and/or characteristic of the user, at least one user-specific electronic recommendation designed to address the predicted event and/or characteristic; and render, on a display screen of a user computing device, the at least one user-specific recommendation.

19. The AI based multi-app system of aspect 18, wherein the at least one user-specific electronic recommendation is displayed on the display screen of the user computing device with a graphical representation of the user as annotated with one or more graphics or textual renderings corresponding to the user-specific electronic recommendation designed to address the predicted event and/or characteristic of the user.

20. The AI based multi-app system of any one of aspects 18-19, wherein the at least one user-specific electronic recommendation is rendered in real-time or near-real time, during, or after the app usage data is received.

21. The AI based multi-app system of any one of aspects 18-20, wherein the at least one user-specific recommendation is output by a speaker of the user computing device as an auditory or verbal recommendation.

22. The AI based multi-app system of any one of aspects 18-21, wherein the at least one user-specific electronic recommendation comprises a product recommendation for a manufactured product.

23. The AI based multi-app system of aspect 22, wherein the at least one user-specific electronic recommendation is displayed on the display screen of the user computing device with instructions for treating, with the manufactured product, the at least one feature identifiable in the app usage data associated with the user, wherein the app usage data comprises pixel data associated with the user.

24. The AI based multi-app system of aspect 22, further comprising the steps of: initiating, based on the product recommendation, the manufactured product for conveyance to the user.

25. The AI based multi-app system of aspect 22, further comprising the steps of: generating, by the one or more processors, a modified image based on an image selected from the app usage data, the modified image depicting a rendering after application of the manufactured product; and rendering, on the display screen of the user computing device, the modified image.

26. The AI based multi-app system of any one of aspects 18-25, wherein the at least one user-specific electronic recommendation is displayed on the display screen of the user computing device with instructions for treating the predicted event and/or characteristic.

27. The AI based multi-app system of any one of aspects 18-26, wherein the multiple existing AI apps comprises one or more of: fit finder app, a biological feature imaging app, a skin analyzer imaging app.

28. The AI based multi-app system of any one of aspects 18-27, wherein the one or more processors comprises at least one of a server or a cloud-based computing platform, and the server or the cloud-based computing platform receives the training data set comprising the plurality of previous predictive outputs of the multiple existing AI apps, and wherein the server or the cloud-based computing platform trains the ensemble AI model with the previous predictive outputs of the multiple existing AI apps.

29. The AI based multi-app system of aspect 28, wherein the server or a cloud-based computing platform receives the app usage data associated with the user, and wherein the server or a cloud-based computing platform executes the ensemble AI model and generates, based on output of the ensemble AI model, the user-specific recommendation and transmits, via a computer network, the user-specific recommendation to the user computing device for rendering on the display screen of the user computing device.

30. The AI based multi-app system of any one of aspects 18-29, wherein the user computing device comprises at least one of a mobile device, a tablet, a handheld device, a desktop device, a home assistant device, a personal assistant device, or a retail computing device.

31. The AI based multi-app system of any one of aspects 18-30, wherein the user computing device receives the app usage data associated with the user, and wherein the user computing device executes the ensemble AI model and generates, based on output of the ensemble AI model, the user-specific recommendation, and renders the user-specific recommendation on the display screen of the user computing device.

32. The AI based multi-app system of any one of aspects 18-31, wherein the app usage data comprises one or more images.

33. The AI based multi-app system of aspect 32, wherein the one or more images are collected using a digital camera.

34. The AI based multi-app system of any one of aspects 18-33, wherein the ensemble AI model is further trained on one or more data sets selected from: medical data, parental data, sensor data, log data, and/or user-specific growth data.

35. A tangible, non-transitory computer-readable medium storing instructions for predicting user-specific events and/or characteristics and generating user-specific recommendations based on app usage, that when executed by one or more processors cause the one or more processors to: aggregate a training data set comprising a plurality of previous predictive outputs of multiple existing AI apps, the previous predictive outputs comprising respective predictions or classifications associated with activities or product usage of respective users; train, with the plurality of predictive outputs, an ensemble AI model operable to predict events and/or characteristics of respective users; receive app usage data associated with a user interacting with an app, wherein the app is selected from the multiple existing AI apps; analyze, by the ensemble AI model, the app usage data to determine a predicted event and/or characteristic of the user; generate, based on the predicted event and/or characteristic of the user, at least one user-specific electronic recommendation designed to address the predicted event and/or characteristic; and render, on a display screen of a user computing device, the at least one user-specific recommendation.

Additional Considerations

Although the disclosure herein sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other embodiments, the one or more processors or processor-implemented modules may be distributed across a number of geographic locations.

This detailed description is to be construed as exemplary only and does not describe every possible embodiment, as describing every possible embodiment would be impractical, if not impossible. A person of ordinary skill in the art may implement numerous alternate embodiments, using either current technology or technology developed after the filing date of this application.

Those of ordinary skill in the art will recognize that a wide variety of modifications, alterations, and combinations can be made with respect to the above described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality and improve the functioning of conventional computers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An artificial intelligence (AI) based multi-application (app) method for predicting user-specific events and/or characteristics and generating user-specific recommendations based on app usage, the AI based multi-app method comprising:
aggregating, at one or more processors communicatively coupled to one or more memories, a training data set comprising a plurality of previous predictive outputs of multiple existing AI apps, the previous predictive outputs comprising respective predictions or classifications associated with activities or product usage of respective users;
training, by the one or more processors with the plurality of predictive outputs, an ensemble AI model operable to predict events and/or characteristics of respective users;
receiving, at the one or more processors, app usage data associated with a user interacting with an app, wherein the app is selected from the multiple existing AI apps;
analyzing, by the ensemble AI model executing on the one or more processors, the app usage data to determine a predicted event and/or characteristic of the user;
generating, by the one or more processors based on the predicted event and/or characteristic of the user, at least one user-specific electronic recommendation designed to address the predicted event and/or characteristic; and
rendering, on a display screen of a user computing device, the at least one user-specific recommendation.

2. The AI based multi-app method of claim 1, wherein the at least one user-specific electronic recommendation is displayed on the display screen of the user computing device with a graphical representation of the user as annotated with one or more graphics or textual renderings corresponding to the user-specific electronic recommendation designed to address the predicted event and/or characteristic of the user.

3. The AI based multi-app method of claim 1, wherein the at least one user-specific electronic recommendation is rendered in real-time or near-real time, during, or after the app usage data is received.

4. The AI based multi-app method of claim 1, wherein the at least one user-specific recommendation is output by a speaker of the user computing device as an auditory or verbal recommendation.

5. The AI based multi-app method of claim 1, wherein the at least one user-specific electronic recommendation comprises a product recommendation for a manufactured product.

6. The AI based multi-app method of claim 5, wherein the at least one user-specific electronic recommendation is displayed on the display screen of the user computing device with instructions for treating, with the manufactured product, the at least one feature identifiable in the app usage data associated with the user, wherein the app usage data comprises pixel data associated with the user.

7. The AI based multi-app method of claim 5, further comprising the steps of:
initiating, based on the product recommendation, the manufactured product for conveyance to the user.

8. The AI based multi-app method of claim 5, further comprising the steps of:
generating, by the one or more processors, a modified image based on an image selected from the app usage data, the modified image depicting a rendering after application of the manufactured product; and
rendering, on the display screen of the user computing device, the modified image.

9. The AI based multi-app method of claim 1, wherein the at least one user-specific electronic recommendation is displayed on the display screen of the user computing device with instructions for treating the predicted event and/or characteristic.

10. The AI based multi-app method of claim 1, wherein the multiple existing AI apps comprises one or more of: fit finder app, a biological feature imaging app, a skin analyzer imaging app.

11. The AI based multi-app method of claim 1, wherein the one or more processors comprises at least one of a server or a cloud-based computing platform, and the server or the cloud-based computing platform receives the training data set comprising the plurality of previous predictive outputs of the multiple existing AI apps, and wherein the server or the cloud-based computing platform trains the ensemble AI model with the previous predictive outputs of the multiple existing AI apps.

12. The AI based multi-app method of claim 11, wherein the server or a cloud-based computing platform receives the app usage data associated with the user, and wherein the server or a cloud-based computing platform executes the ensemble AI model and generates, based on output of the ensemble AI model, the user-specific recommendation and transmits, via a computer network, the user-specific recommendation to the user computing device for rendering on the display screen of the user computing device.

13. The AI based multi-app method of claim 1, wherein the user computing device comprises at least one of a mobile device, a tablet, a handheld device, a desktop device, a home assistant device, a personal assistant device, or a retail computing device.

14. The AI based multi-app method of claim 1, wherein the user computing device receives the app usage data associated with the user, and wherein the user computing device executes the ensemble AI model and generates, based on output of the ensemble AI model, the user-specific recommendation, and renders the user-specific recommendation on the display screen of the user computing device.

15. The AI based multi-app method of claim 1, wherein the app usage data comprises one or more images.

16. The AI based multi-app method of claim 15, wherein the one or more images are collected using a digital camera.

17. The AI based multi-app method of claim 1, wherein the ensemble AI model is further trained on one or more data sets selected from: medical data, parental data, sensor data, log data, and/or user-specific growth data.

18. An artificial intelligence (AI) based multi-application (app) system configured to predict user-specific events and/or characteristics and generate user-specific recommendations based on app usage, the AI based multi-app system comprising:
a server comprising a server processor and a server memory;
an multiple application (app) configured to execute on a user computing device comprising a device processor and a device memory, the multiple app communicatively coupled to the server, and the multiple app configured to launch or access multiple existing AI apps, and the multiple app configured to launch or access multiple existing AI apps; and
an ensemble AI model trained with a training data set comprising a plurality of previous predictive outputs of the multiple existing AI apps, the previous predictive outputs comprising respective predictions or classifications associated with activities or product usage of respective users, wherein the ensemble AI model is configured to predict events and/or characteristics of respective users, and
wherein computing instructions stored in the server memory are configured to execute on the server processor or the device processor to cause the server processor or the device processor to:
receive, at the one or more processors, app usage data associated with a user interacting with an app, wherein the app is selected from the multiple existing AI apps;
analyze, by the ensemble AI model executing on the one or more processors, the app usage data to determine a predicted event and/or characteristic of the user;
generate, by the one or more processors based on the predicted event and/or characteristic of the user, at least one user-specific electronic recommendation designed to address the predicted event and/or characteristic; and
render, on a display screen of a user computing device, the at least one user-specific recommendation.

19. The AI based multi-app system of claim 18, wherein the at least one user-specific electronic recommendation is displayed on the display screen of the user computing device with a graphical representation of the user as annotated with one or more graphics or textual renderings corresponding to the user-specific electronic recommendation designed to address the predicted event and/or characteristic of the user.

20. The AI based multi-app system of claim 18, wherein the at least one user-specific electronic recommendation is rendered in real-time or near-real time, during, or after the app usage data is received.

21. The AI based multi-app system of claim 18, wherein the at least one user-specific recommendation is output by a speaker of the user computing device as an auditory or verbal recommendation.

22. The AI based multi-app system of claim 18, wherein the at least one user-specific electronic recommendation comprises a product recommendation for a manufactured product.

23. The AI based multi-app system of claim 22, wherein the at least one user-specific electronic recommendation is displayed on the display screen of the user computing device with instructions for treating, with the manufactured product, the at least one feature identifiable in the app usage data associated with the user, wherein the app usage data comprises pixel data associated with the user.

24. The AI based multi-app system of claim 22, further comprising the steps of:
initiating, based on the product recommendation, the manufactured product for conveyance to the user.

25. The AI based multi-app system of claim 22, further comprising the steps of:
generating, by the one or more processors, a modified image based on an image selected from the app usage data, the modified image depicting a rendering after application of the manufactured product; and
rendering, on the display screen of the user computing device, the modified image.

26. The AI based multi-app system of claim 18, wherein the at least one user-specific electronic recommendation is displayed on the display screen of the user computing device with instructions for treating the predicted event and/or characteristic.

27. The AI based multi-app system of claim 18, wherein the multiple existing AI apps comprises one or more of: fit finder app, a biological feature imaging app, a skin analyzer imaging app.

28. The AI based multi-app system of claim 18, wherein the one or more processors comprises at least one of a server or a cloud-based computing platform, and the server or the cloud-based computing platform receives the training data set comprising the plurality of previous predictive outputs of the multiple existing AI apps, and wherein the server or the cloud-based computing platform trains the ensemble AI model with the previous predictive outputs of the multiple existing AI apps.

29. The AI based multi-app system of claim 28, wherein the server or a cloud-based computing platform receives the app usage data associated with the user, and wherein the server or a cloud-based computing platform executes the ensemble AI model and generates, based on output of the ensemble AI model, the user-specific recommendation and transmits, via a computer network, the user-specific recommendation to the user computing device for rendering on the display screen of the user computing device.

30. The AI based multi-app system of claim 18, wherein the user computing device comprises at least one of a mobile device, a tablet, a handheld device, a desktop device, a home assistant device, a personal assistant device, or a retail computing device.

31. The AI based multi-app system of claim 18, wherein the user computing device receives the app usage data associated with the user, and wherein the user computing device executes the ensemble AI model and generates, based on output of the ensemble AI model, the user-specific recommendation, and renders the user-specific recommendation on the display screen of the user computing device.

32. The AI based multi-app system of claim 18, wherein the app usage data comprises one or more images.

33. The AI based multi-app system of claim 32, wherein the one or more images are collected using a digital camera.

34. The AI based multi-app system of claim 18, wherein the ensemble AI model is further trained on one or more data sets selected from: medical data, parental data, sensor data, log data, and/or user-specific growth data.

35. A tangible, non-transitory computer-readable medium storing instructions for predicting user-specific events and/or characteristics and generating user-specific recommendations based on app usage, that when executed by one or more processors cause the one or more processors to:
aggregate a training data set comprising a plurality of previous predictive outputs of multiple existing AI apps, the previous predictive outputs comprising respective predictions or classifications associated with activities or product usage of respective users;
train, with the plurality of predictive outputs, an ensemble AI model operable to predict events and/or characteristics of respective users;
receive app usage data associated with a user interacting with an app, wherein the app is selected from the multiple existing AI apps;
analyze, by the ensemble AI model, the app usage data to determine a predicted event and/or characteristic of the user;
generate, based on the predicted event and/or characteristic of the user, at least one user-specific electronic recommendation designed to address the predicted event and/or characteristic; and
render, on a display screen of a user computing device, the at least one user-specific recommendation.
